(19) United States
(12) Patent Application Publication
(10) Pub. No.: US 2006/0230873 A1
(43) Pub. Date: Oct. 19, 2006

(54) Steering wheel and method of manufacturing

(75) Inventor: Roberto C. Buiocchi, Jundiai (BR)

Correspondence Address: FOLEY AND LARDNER LLP;SUITE 500, 3000 K STREET NW, WASHINGTON, DC, 20007, US

(73) Assignee: TAKATA-PETRI INC.

(21) Appl. No.: 11/254,728

(22) Filed: Oct. 21, 2005

Related U.S. Application Data
(60) Provisional application No. 60/671,513, filed on Apr. 15, 2005.

(51) Int. Cl. B62D 1/04; B29C 45/14

(52) U.S. Cl. 74/552; 264/275

(57) ABSTRACT

A steering wheel includes a steering wheel ring, a first spacer in contact with an outer surface of the steering wheel ring at a first location, and a second spacer in contact with the outer surface of the steering wheel ring at a second location. At least one armature is coupled to the steering wheel ring at the first location and the second location, the material of the armature at least partially enveloping the first spacer and the second spacer.

### CROSS-REFERENCE TO RELATED PATENT APPLICATIONS

This application is claims the benefit under 35 U.S.C. § 119(e) of U.S. Provisional Patent Application No. 60/671,513, filed Apr. 15, 2005, which is incorporated herein by reference in its entirety.

### BACKGROUND

The present invention relates generally to vehicle steering wheels. In particular, the present invention relates to method of manufacturing steering wheels and, most particularly, the steering wheel armature.

Steering wheels typically include a number of spokes or armatures coupled between a center portion or hub and a tubular ring. The armatures are typically made of die cast magnesium, aluminum, or other suitable materials, while the tubular ring is typically made of steel or another suitable material.

In some instances, the central portion and armature may be formed from the die cast material and connected to a tubular ring insert to form the basic structure of the steering wheel. Such conventional designs are limited due to the relative strength of the tubular ring. For example, if the tubular ring does not have sufficient strength to withstand the force of coupling with the spokes, then problems can occur during the casting of the magnesium armature. In particular, the die casting pressure may cause defects in the tubular ring if the pressure exerted on the tubular ring is concentrated in particular areas of the tubular ring.

It would be desirable to provide a method for producing a steering wheel formed from a tubular ring and a cast armature that reduces the occurrence of defects resulting from the casting process. It would also be desirable to provide for producing a steering wheel in which stress is more uniformly applied to the tubular ring during the armature casting process. It would be desirable to provide a manufacturing process that provides any one or more of these or other features as may be appreciated by those reviewing this disclosure.

### SUMMARY

An exemplary embodiment of the invention relates to a steering wheel that includes a steering wheel ring, a first spacer in contact with an outer surface of the steering wheel ring at a first location, and a second spacer in contact with the outer surface of the steering wheel ring at a second location. At least one armature is coupled to the steering wheel ring at the first location and the second location, the material of the armature at least partially enveloping the first spacer and the second spacer

Another exemplary embodiment of the invention relates to a method for producing a steering wheel that includes providing a plurality of mold inserts in contact with an exterior surface of a steering wheel ring, providing the steering wheel ring and the mold inserts into a mold cavity, and introducing a material into the mold cavity to form an armature coupled to the steering wheel ring.

Another exemplary embodiment of the invention relates to a method of producing a steering wheel that includes providing a steering wheel ring in a mold cavity, spacing an outer surface of the steering wheel ring away from walls of the mold cavity with a plurality of spacers coupled to the steering wheel ring, and molding an armature to the steering wheel ring by providing a metal in the mold cavity.

It is to be understood that both the foregoing general description and the following detailed description are exemplary and explanatory only and are not restrictive of the invention as claimed.

### BRIEF DESCRIPTION OF THE DRAWINGS

These and other features, aspects, and advantages of the present invention will become apparent from the following description, appended claims and the accompanying exemplary embodiments shown in the drawings, which are briefly described below.

FIG. 1 is a top plan view of a portion of a steering wheel showing a connection between a steering wheel tubular rim and spoke portion according to an exemplary embodiment.

FIG. 2 is a cross-sectional view of a steering wheel such as that shown in FIG. 1 illustrating a prior art molding process.

FIG. 3 is a cross-sectional view of the steering wheel shown in FIG. 1 taken across line 3-3.

FIG. 4 is a cross-sectional view of the steering wheel shown in FIG. 1 taken across line 4-4.

FIG. 5 is a flow diagram illustrating steps in a method of producing a steering wheel according to an exemplary embodiment.

### DETAILED DESCRIPTION OF EXEMPLARY EMBODIMENTS

According to an exemplary embodiment, an improved process for manufacturing steering wheels utilizes mold inserts or spacers in the die casting process used to form the steering wheel. The mold inserts may be coupled or attached to the steering wheel ring (e.g., are provided in contact with the steering wheel ring) prior to the provision of the steering wheel ring into the cavity of the mold or die. During introduction of a material (e.g., a metal such as magnesium or aluminum) into the mold to form an armature coupled to the steering wheel ring, the mold inserts act to space the steering wheel ring away from walls of the mold (e.g., to allow the material to flow around the outer surface of the steering wheel ring) and to provide an improved stress profile in the steering wheel ring during the casting process that reduces the occurrence of damage to the steering wheel ring.

As shown in FIG. 1, a portion of a steering wheel 100 is shown that includes a hollow steering wheel ring 110 having an opening 112 formed therethrough and an armature 120 coupled or attached to the steering wheel ring. According to an exemplary embodiment, the armature 120 is molded or cast to the steering wheel ring in a die casting process. Although not shown in particular in the drawings appended hereto, the steering wheel 100 may include conventional elements such as shown in U.S. Pat. No. 6,193,267 and U.S. Pat. No. 6,675,675, both of which are incorporated herein by reference in their entirety. It should be noted that the steering wheel ring may have any of a variety of configurations, and need not necessarily have a circular cross-section or be provided in the form of an annular ring.

The materials used to form the steering wheel ring and the armature may vary according to various exemplary embodiments. According to a particular exemplary embodiment, the steering wheel ring is made of steel and the armature is cast from magnesium, aluminum, or alloys thereof. The particular materials utilized may be selected for a particular application based on a number of factors, including strength, weight, and other considerations.

The size, shape, and configuration of the steering wheel ring and armature may also vary according to various exemplary embodiments. For example, while the cross-sectional shape of the steering wheel ring is shown as being substantially circular, it should be noted that according to other embodiments, the cross-sectional shape of the steering wheel ring may differ.

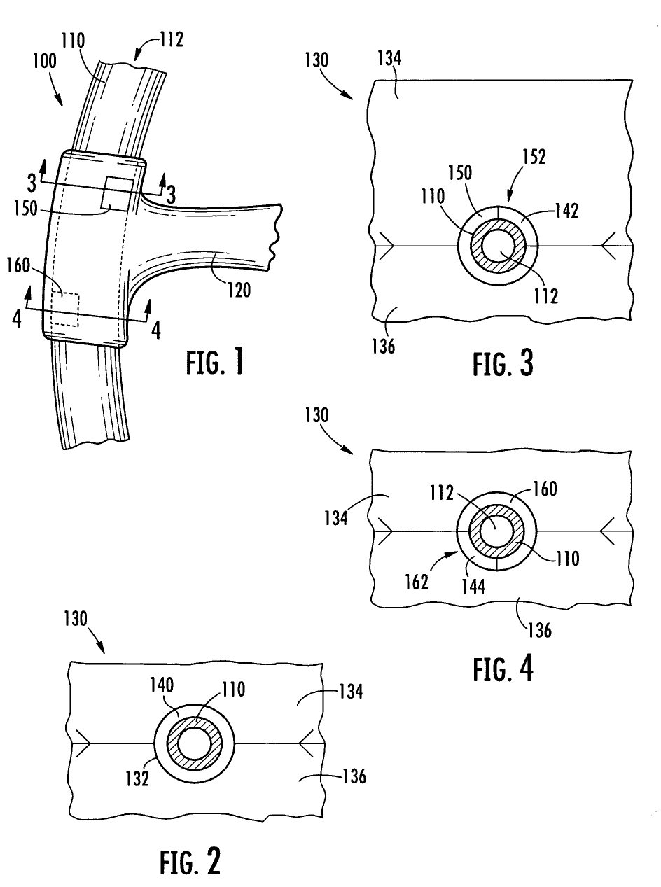

The steering wheel ring 110 is held in position during the die casting process in which the magnesium (or other suitable material) portion is cast. FIG. 2 illustrates a conventional method for producing a steering wheel in which a steering wheel ring (shown as ring 110 for simplicity) is provided within a cavity 132 of a mold 130 defined by mold halves 134 and 136. No inserts or spacers are provided to maintain the steering wheel ring in the center of the cavity 132. The material 140 inserted within the cavity 132 of the mold 134 thus flows around the outside of the steering wheel ring during the die casting process. Because the steering wheel ring is unsupported during the die casting process, the flow of material around the steering wheel ring may result in an unequal stress concentration at certain points along the steering wheel ring.

In contrast, according to an exemplary embodiment of the present invention as shown in FIGS. 3-4, the steering wheel ring is held by spacers or mold inserts at attachment points that are offset in order to control the “centering” of the ring during the casting process. As a result, the armature exhibits improved performance and consistence in quality (e.g., because the ring is centered in the mold, stress concentrations do not build up in one location of the ring). Other advantages include increased flexibility of tubular ring designs, improved steering wheel performance and stress analysis, and improved quality and production.

FIG. 3 is a cross-sectional view of the steering wheel 100 shown in FIG. 1 taken across line 3-3, while FIG. 4 is a cross-sectional view of the steering wheel 100 shown in FIG. 1 taken across line 4-4. As shown in FIGS. 3 and 4, a first mold insert or spacer 150 and a second mold insert or spacer 160 are provided in contact with (e.g., coupled or attached to) the steering wheel ring 110. According to an exemplary embodiment, the mold inserts may be provided in the form of clips that may be attached to the steering wheel ring and have a thickness of between approximately 6 mm and 12 mm.

The mold inserts 150 and 160 do not extend around the entire external surface of the steering wheel ring. For example, as shown in FIGS. 3 and 4, the mold inserts 150 and 160 have a generally “C” shaped configuration (i.e., the mold inserts have terminal ends which do not meet or touch). It should be noted that mold inserts having different sizes, shapes, and/or configurations may be used according to other exemplary embodiments. As shown in FIGS. 3 and 4, the mold inserts 150 and 160 extend around approximately three-quarters of the distance around the external surface of the steering wheel ring 110. Such a configuration allows material to flow along the a portion of the surface of the steering wheel ring adjacent the mold inserts 150 and 160 (as shown in FIG. 3, a material 142 fills the space or gap 152 between the steering wheel ring 110 and the walls of the mold, and in FIG. 4, a material 144 fills the space or gap 162 between the steering wheel ring 110 and the walls of the mold).

The mold inserts 150 and 160 are offset relative to each other as shown in FIG. 1 (e.g., the mold insert 150 is positioned differently on the steering wheel ring 110 than the mold insert 160, such that the open spaces 152 and 162 defined by the “C” shaped mold inserts are not aligned with each other). The offset positioning of the mold inserts is intended to aid in centering the steering wheel ring 110 within the cavity 132 of the mold 130 during the casting process. While FIGS. 3 and 4 illustrate a situation in which the mold inserts are positioned such that the open spaces 152 and 162 are entirely out of alignment with each other (e.g., the open spaces are arranged 180 degrees on the opposite side of the steering wheel ring from each other), according to other exemplary embodiments, there may be a partial alignment of the open spaces with each other. Any of a variety of configurations for the open spaces and their alignment with each other may be contemplated in other exemplary embodiments.

The mold inserts 150 and 160 may be formed of any of a variety of suitable materials. According to an exemplary embodiment, the mold inserts 150 and 160 are formed from a similar or identical material as that used to form the armature (e.g., magnesium, aluminum, or an alloy thereof) such that the steering wheel ring 110 is circumscribed at points 3-3 and 4-4 by such material. According to other exemplary embodiments, other suitable materials may be utilized to form the mold inserts.

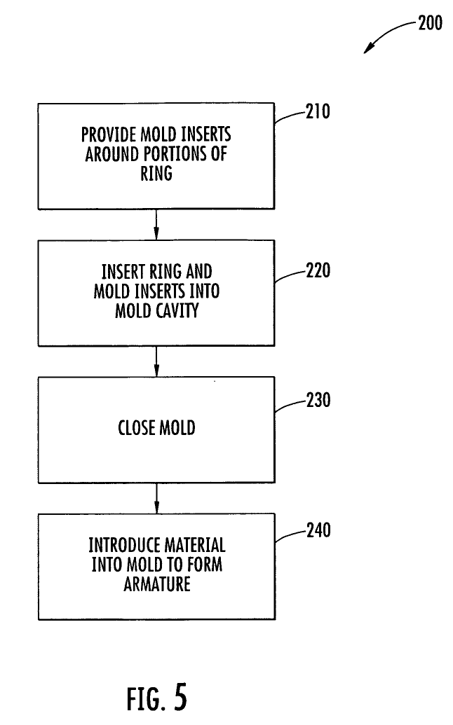

FIG. 5 is a flow diagram illustrating steps in a method 200 of producing a steering wheel according to an exemplary embodiment. In a first step 210, the mold inserts (e.g., mold inserts 150 and 160) are provided around portions of the steering wheel ring (e.g., ring 110). While FIGS. 1 and 3-4 illustrate the use of two such mold inserts on one side of the steering wheel 100, according to other exemplary embodiments, any number of mold inserts may be utilized as may be desirable for a particular application. For example, three or more mold inserts may be provided.

In a step 220, the steering wheel ring and mold inserts in contact therewith are inserted into a cavity of a mold or die, and the mold is closed in a step 230 around the steering wheel ring and mold inserts. Material such as molten magnesium or another material is introduced (e.g., injected, gravity filled) into the mold in a step 240. The material flows into the cavity in the mold to form the armature that is coupled or attached to the steering wheel ring. The material is able to flow adjacent to portions of the steering wheel ring such that the armature is cast to the steering wheel ring. Additionally, the material is able to flow into the spaces defined by the open portion of the mold inserts (e.g., the open portion of the “C” shaped inserts) such that the mold inserts are partially surrounded by the material. According to an exemplary embodiment, the material used to form the mold inserts may be the same or similar to that material which is introduced into the mold cavity. According to other exemplary embodiments, the material used to form the mold inserts may differ from such material (e.g., the mold insert may be formed of aluminum or an aluminum alloy while the material used to form the armature is magnesium or a magnesium alloy).

While the above embodiments have described a method in which the mold inserts 150 and 160 are coupled or attached to the steering wheel ring 110 prior to placement of the steering wheel ring 110 into the mold, it should be noted that according to other exemplary embodiments, the mold inserts may be provided in the mold prior to placement of the steering wheel ring into the mold.

It is important to note that the steering wheel and method of manufacture as shown and described with respect to the various exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. Accordingly, all such modifications are intended to be included within the scope of the present invention as defined in the appended claims. The order or sequence of any process or method steps may be varied or re-sequenced according to alternative embodiments. Other substitutions, modifications, changes and omissions may be made in the design, operating conditions and arrangement of the various exemplary embodiments without departing from the scope of the present inventions as expressed in the appended claims.

What is claimed is:

1. A steering wheel comprising:
a steering wheel ring;
a first spacer in contact with an outer surface of the steering wheel ring at a first location;
a second spacer in contact with the outer surface of the steering wheel ring at a second location;
at least one armature coupled to the steering wheel ring at the first location and the second location, the material of the armature at least partially enveloping the first spacer and the second spacer.

2. The steering wheel of claim 1, wherein the steering wheel ring is a hollow metal tube.

3. The steering wheel of claim 2, wherein the material used to form the armature is selected from the group consisting of aluminum, magnesium, and alloys and combinations thereof.

4. The steering wheel of claim 1, wherein the spacers are provided as clips having terminal ends which do not meet.

5. The steering wheel of claim 4, wherein the spacers are generally “C” shaped.

6. The steering wheel of claim 1, wherein the spacers are offset from one another to assist in centering the steering wheel ring in a mold.

7. The steering wheel of claim 1, wherein the spacers have a thickness of between approximately 6 mm and 12 mm.

8. A method for producing a steering wheel, comprising:
providing a plurality of mold inserts in contact with an exterior surface of a steering wheel ring;
providing the steering wheel ring and the mold inserts into a mold cavity; and
introducing a material into the mold cavity to form an armature coupled to the steering wheel ring.

9. The steering wheel of claim 8, wherein the material introduced into the mold cavity is selected from the group consisting of aluminum, magnesium, and alloys and combinations thereof.

10. The steering wheel of claim 9, wherein the mold inserts are made from a material selected from the group consisting of aluminum, magnesium, and alloys and combinations thereof.

11. The steering wheel of claim 8, wherein the steering wheel ring is provided as a hollow metal tube.

12. The steering wheel of claim 8, wherein the steering wheel comprises a steel material.

13. The steering wheel of claim 8, wherein the spacers are offset with respect to each other around the outer surface of the steering wheel ring.

14. The steering wheel of claim 8, wherein the spacers comprise terminal ends that do not touch when provided in contact with the steering wheel ring.

15. A method of producing a steering wheel comprising:
providing a steering wheel ring in a mold cavity;
spacing an outer surface of the steering wheel ring away from walls of the mold cavity with a plurality of spacers coupled to the steering wheel ring; and
molding an armature to the steering wheel ring by providing a metal in the mold cavity.

16. The steering wheel of claim 15, wherein the spacers are provided as clips.

17. The steering wheel of claim 15, wherein the metal provided in the mold cavity comprises magnesium.

18. The steering wheel of claim 15, wherein the spacers are configured to space the steering wheel ring between approximately 6 mm and 12 mm away from the walls of the mold cavity.

19. The steering wheel of claim 15, wherein the spacers are offset from each other to assist in centering the steering wheel ring in the mold cavity.

20. The steering wheel of claim 15, wherein the metal at least partially envelops the spacers.
